(19) United States
(12) Patent Application Publication
(10) Pub. No.: US 2026/0094264 A1
(43) Pub. Date: Apr. 2, 2026

(54) SYSTEM AND METHOD FOR SEGMENTING FACIAL WRINKLE

(71) Applicant: HANKUK UNIVERSITY OF FOREIGN STUDIES RESEARCH & BUSINESS FOUNDATION, Yongin-si (KR)

(72) Inventors: Ikbeom JANG, Seongnam-si (KR); Junho MOON, Seoul (KR)

(73) Assignee: HANKUK UNIVERSITY OF FOREIGN STUDIES RESEARCH & BUSINESS FOUNDATION, Yongin-si (KR)

(21) Appl. No.: 18/956,571

(22) Filed: Nov. 22, 2024

(30) Foreign Application Priority Data
Sep. 30, 2024 (KR) 10-2024-0133297

(51) Int. Cl. G06T 7/00; G06T 7/40; G06V 10/56; G06V 10/778; G06V 10/82

(52) U.S. Cl. CPC G06T 7/0012; G06T 7/40; G06V 10/56; G06V 10/7784; G06V 10/82; G06T 2207/10024; G06T 2207/20081; G06T 2207/20084; G06T 2207/30088; G06T 2207/30201

(57) ABSTRACT

Proposed are a system and a method for detecting a facial wrinkle. A deep neural network pre-trained by weakly supervised learning performed with a predetermined number or more of images is used to fine-tune the weight of the pre-trained deep neural network with fewer than a predetermined number of images so that the performance of a facial wrinkle model constructed with fewer than the predetermined number of the images is improved, thereby enabling the detection of a wrinkle with improved accuracy, and there is an effect of reducing human time and cost required for detecting facial wrinkles by detecting the facial wrinkles with fewer than a predetermined number of images.

### BACKGROUND OF THE INVENTION

### Field of the Invention

The present disclosure relates generally to a system and a method for detecting a facial wrinkle. More particularly, the present disclosure relates to a technology in which a deep learning neural network pre-trained by weakly supervised learning performed with a predetermined number or more of images is used to fine-tune the weight of the pre-trained deep learning neural network with fewer than a predetermined number of images so that the performance of a facial wrinkle model constructed with fewer than the predetermined number of the images is improved, thereby enabling the detection of a wrinkle with improved accuracy.

### Description of the Related Art

As interest in skin diseases and skin beauty increases, the accuracy of facial wrinkle prediction is increasing.

A facial wrinkle is an important indicator of aging, and accurate facial wrinkle detection plays an important role in skin condition evaluation, skin disease diagnosis, and preoperative treatment for skin care.

Facial wrinkle detection is performed manually by well-trained experts, and thus there is room for human judgment error and time and cost required to manually detect facial wrinkles have reached significant limitations.

### SUMMARY OF THE INVENTION

Accordingly, the present disclosure has been made keeping in mind the above problems occurring in the related art, and an objective of the present disclosure is to provide a system and a method for detecting a facial wrinkle which are capable of improving the performance of a facial wrinkle model constructed with fewer than a predetermined number of images, thereby enabling the detection of a wrinkle with improved accuracy.

In addition, another technical objective of the present disclosure is to provide a system and a method for detecting a facial wrinkle, which are capable of reducing human time and cost required for detecting facial wrinkles by detecting the facial wrinkles with fewer than a predetermined number of images.

The objectives of the present disclosure are not limited to the objectives mentioned above, and other objectives and advantages of the present disclosure that are not mentioned can be understood by the following description and will be more clearly known by the embodiments of the present disclosure. Furthermore, it will be readily apparent that the objectives and advantages of the present disclosure can be achieved by means set forth in the claims and combinations thereof.

In order to achieve the objectives of the present disclosure, according to an aspect of the present disclosure, there is provided a facial wrinkle detection system including: a weakly supervised learning device that converts each of a predetermined number or more of collected images into RGB data, extracts facial RGB data, and then estimates a texture map through training of a deep learning neural network by using the extracted facial RGB data as inputs; and a supervised learning device that estimates wrinkle data through transfer learning of the deep learning neural network pre-trained on the basis of the weakly supervised learning device by using combined data of preprocessed wrinkle RGB data from fewer than a predetermined number of input images and the texture map as inputs.

Preferably, the weakly supervised learning device may include: a preprocessing module that converts each of the predetermined number or more of the collected images to the RGB data, extracts RGB data of a facial region from the converted RGB data, and then derives a texture map for the facial RGB data through a Gaussian filter; a weakly supervised learning module that trains the deep neural network with the facial RGB data and estimates a texture map; and a weakly supervised loss function computation module that trains the deep learning neural network by updating a weight of the deep neural network based on a mean squared error (MSE) calculated from the difference between the estimated texture map of the weakly supervised learning module and the ground truth texture map.

Preferably, the texture map may be label information including facial contours, curves, and skin texture features.

Preferably, the supervised learning device may include: a wrinkle region derivation module that derives combined data by combining the preprocessed wrinkle RGB data from fewer than the predetermined number of the input images and a texture map derived from the wrinkle RGB data through the Gaussian filter, based on a channel-wise concatenation operation, derives each of binary wrinkle data with a mask determined by at least one annotator for fewer than the predetermined number of the input images, and outputs one piece of wrinkle data by combining each of the binary wrinkle data through a majority voting algorithm; a supervised learning module that estimates the wrinkle data through the transfer learning of the deep learning neural network pre-trained on the basis of the weakly supervised learning device with the combined data as the inputs; and a supervised loss function computation module that fine-tunes a weight of the pre-trained deep neural network based on a soft dice loss calculated from the difference between the estimated wrinkle data of the supervised learning module and the ground truth wrinkle data, wherein the supervised learning module may be provided to output optimal wrinkle data as a result of the transfer learning of the fine-tuned deep neural network.

Preferably, the wrinkle data may include label information including wrinkle presence and background.

According to another aspect of the present disclosure, a facial wrinkle detection method of an embodiment includes: a weakly supervised learning for converting each of the predetermined number or more of the collected images into the RGB data, extracting the facial RGB data, and then estimating the texture map through the training of the deep neural network by using the extracted facial RGB data as the inputs; and a supervised learning for estimating the wrinkle data through the transfer learning of the deep neural network pre-trained on the basis of the weakly supervised learning device by using the combined data of the preprocessed wrinkle RGB data from fewer than the predetermined number of the input images and the texture map as the inputs.

Preferably, the weakly supervised learning may include: converting each of the predetermined number or more of the collected images into the RGB data, extracting RGB data of a facial region from the converted RGB data, and then deriving a ground truth texture map for the facial RGB data through a Gaussian filter; training the deep neural network with the facial RGB data and estimating a texture map; and training the deep learning neural network by updating a weight of the deep neural network based on the MSE calculated from the difference between the estimated texture map of the weakly supervised learning module and the ground truth texture map.

Preferably, the supervised learning stage may include: deriving combined data by combining the preprocessed wrinkle RGB data from fewer than the predetermined number of the input images and a texture map derived from the wrinkle RGB data through the Gaussian filter, based on a channel-wise concatenation operation, deriving each of binary wrinkle data with a mask determined by at least one annotator for fewer than the predetermined number of the input images, and outputting a consolidated ground truth wrinkle data by combining each of the binary wrinkle data through a majority voting algorithm; estimating the wrinkle data through the transfer learning of the deep neural network pre-trained on the basis of the weakly supervised learning device with the combined data as the inputs; and fine-tuning a weight of the pre-trained deep neural network based on a soft dice loss calculated from the difference between the estimated wrinkle data of the supervised learning module and the ground truth wrinkle data, wherein the supervised learning may further include outputting optimal wrinkle data as a result of the transfer learning of the fine-tuned deep neural network.

According to these features, a deep neural network pre-trained by weakly supervised learning performed with a predetermined number or more of images is used to fine-tune the weight of the pre-trained deep neural network with fewer than a predetermined number of images so that the performance of a facial wrinkle segmentation model constructed with fewer than the predetermined number of the images is improved, thereby enabling the detection of a wrinkle with improved accuracy.

Accordingly, according to the present disclosure, there is an effect of reducing human time and cost required for detecting facial wrinkles by detecting the facial wrinkles with fewer than a predetermined number of images.

### BRIEF DESCRIPTION OF THE DRAWINGS

The following drawings attached to this specification illustrate preferred embodiments of the present disclosure and, together with the detailed description of the invention to be described below, serve to help the further understanding of the technical idea of the present disclosure. Therefore, the present disclosure should not be interpreted as being limited to matters described in such drawings.

FIG. 1 is a configuration diagram of a facial wrinkle detection system according to an embodiment.

FIG. 2 is a detailed configuration diagram of the facial wrinkle detection system of FIG. 1.

FIG. 3 is a detailed configuration diagram of a weakly supervised learning device of FIG. 1.

FIG. 4 is a detailed configuration diagram of a supervised learning device of FIG. 1.

FIG. 5 is a view illustrating masks determined on the basis of annotators A to C used as inputs for a wrinkle region derivation part of FIG. 4.

FIG. 6 is a view illustrating the output images of each part of FIG. 1.

FIG. 7 is an overall flowchart showing a facial wrinkle detection process of another embodiment.

### DETAILED DESCRIPTION OF THE INVENTION

Below, with reference to the attached drawings, embodiments of the present disclosure are described in detail so that those skilled in the art to which the present disclosure belongs can easily implement the present disclosure. However, the present disclosure may be implemented in many different forms and is not limited to the embodiments described herein. In addition, in order to clearly explain the present disclosure in the drawings, parts that are not related to the explanation have been omitted, and similar parts have been given similar reference numerals throughout the specification.

The following embodiment specifically describes the configuration of a facial wrinkle detection system.

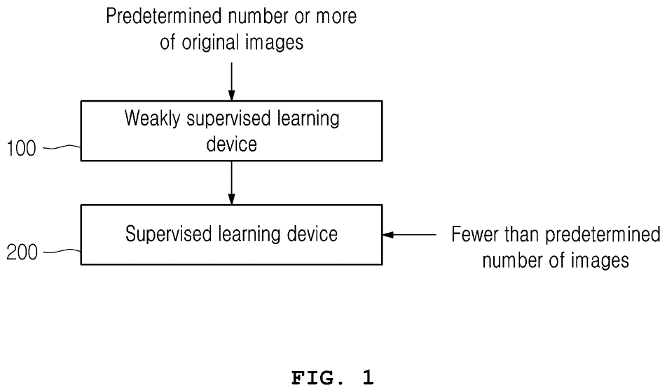

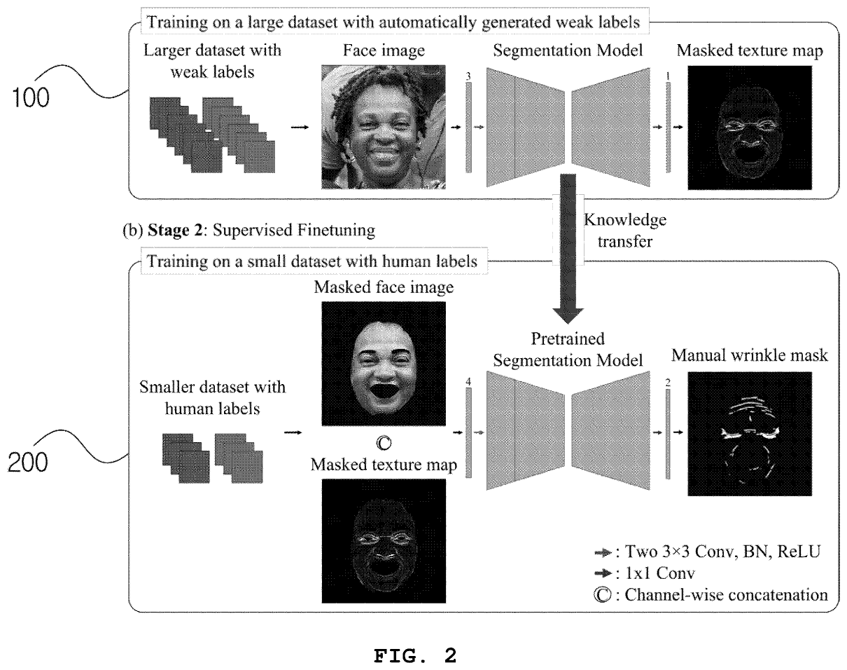

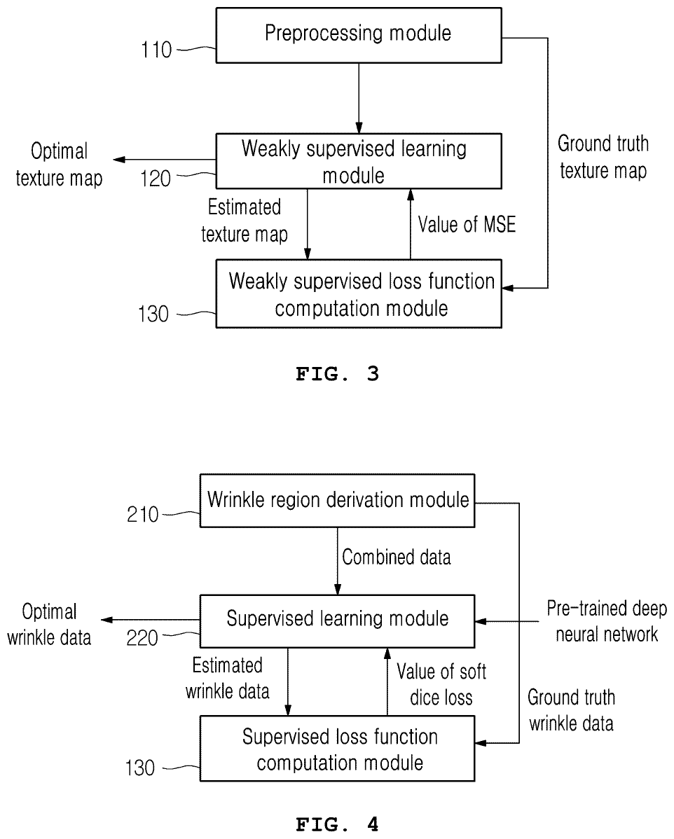

FIG. 1 is a configuration diagram of the facial wrinkle detection system according to an embodiment, FIG. 2 is a detailed configuration diagram of the facial wrinkle detection system of FIG. 1, FIG. 3 is a detailed configuration diagram of a weakly supervised learning device of FIG. 1, and FIG. 4 is a detailed configuration diagram of a supervised learning device of FIG. 1.

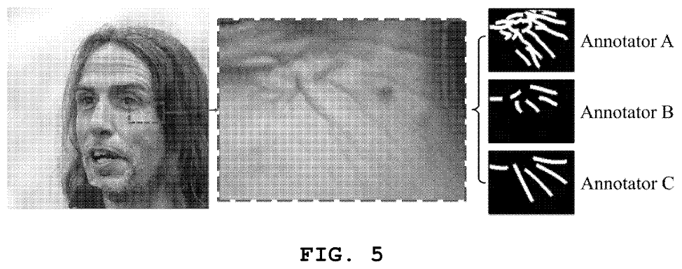

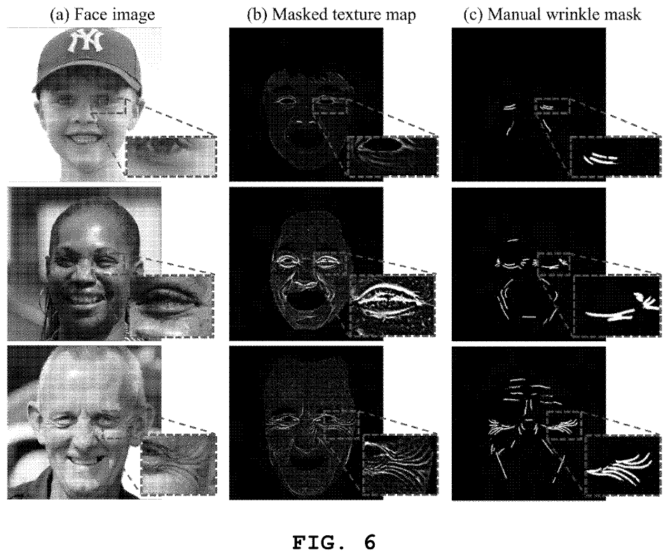

FIG. 5 is a view illustrating masks determined on the basis of annotators A to C used as inputs for a wrinkle region derivation part of FIG. 4, and FIG. 6 is a view illustrating the output images of each part of FIG. 1. Referring to FIGS. 1 to 6, the facial wrinkle detection system may include a weakly supervised learning device 100 and a supervised learning device 200 that trains a deep neural network with a predetermined number or more of collected facial images to output an optimal texture map, and outputs optimal wrinkle data for fewer than a predetermined number of input facial images by fine-tuning the pre-trained deep learning neural network.

The weakly supervised learning device 100 is configured to convert predetermined number or more of collected facial images into RGB data, then to learn the extracted facial RGB data as inputs through the deep neural network to estimate each texture map, and to train the deep neural network by updating weights based on an MSE calculated from the difference between the estimated texture map and the ground truth texture map. Accordingly, referring to FIG. 3, the weakly supervised learning device 100 may include a preprocessing module 110, a weakly supervised learning module 120, and a weakly supervised loss function computation module 130.

Here, the preprocessing module 110 converts a predetermined number or more of original images into RGB data by using a digital image technique, then extracts facial RGB data from the RGB data, and generates the ground truth texture map for the extracted facial RGB data through a Gaussian filter. In this case, the ground truth texture map T (x, y) that is output may be expressed by the following equation 1.

$$T ( x , y ) = ( 1 - \frac{I ( x , y )}{1 + {I}_{G ( σ )} ( x , y )} ) \times 255 \qquad [ Equation 1 ]$$

Here, G is a Gaussian kernel, σ is standard deviation of the Gaussian kernel, l is an original face image, I_{G(σ)} is Gaussian filtered face image, and (x, y) are the pixel coordinates of the image.

In addition, the extracted facial RGB data is provided to the weakly supervised learning module 120.

The weakly supervised learning module 120 inputs the facial RGB data and learns the facial RGB data through the deep module neural network to output the estimated texture map including information about the contour, curvature, and skin texture of each face.

For example, the deep neural network may be implemented as various semantic segmentation (neural networks), and for another example, as illustrated in FIG. 2, the deep neural network, which is a deep neural network based on the U-Net and Swin UNETR architectures, may be implemented as an autoencoder that sequentially performs encoding and decoding. The deep neural network may be implemented as, but is not limited to, convolution operations (Conv), batch Normalization (BN), ReLu activation functions, downsampling operations of max pooling, bilinear upsampling operations, channel-specific attention operations, etc.

Next, the estimated texture map of the weakly supervised learning module 120 and the ground truth texture map of the preprocessing module 110 are provided to the weakly supervised loss function computation module 130, and the weakly supervised loss function computation module 130 trains the deep neural network by updating weights of the deep neural network based on the MSE calculated from the difference between the estimated texture map of the deep neural network and the ground truth texture map, and outputs the optimal texture map. Here, the MSE of the deep neural network may be expressed by Equation 2 below.

$$MSE ( y , y ) = \frac{1}{n} {\sum }_{i = 1}^{n} {( {\hat{y}}_{i} - {y}_{i} )}^{2} \qquad [ Equation 2 ]$$

Here, ŷᵢ and yᵢ are the estimated texture map and the ground truth texture map, respectively. In addition, a texture map model may be built with label information generated from the derived estimated texture map.

Meanwhile, the supervised learning device 200 converts fewer than a predetermined number of input images into RGB data, extracts wrinkle RGB data by removing false positives such as teeth and hair from the converted RGB data, merges texture maps derived by a Gaussian filter for the extracted wrinkle RGB data on the basis of a channel-wise concatenation operation to output combined data, combines binary wrinkle data derived by wrinkle masks predefined on the basis of at least one of annotators A to C for the input images fewer than a predetermined number through a majority voting algorithm to generate and output a consolidated ground truth wrinkle data, estimates wrinkle data through transfer learning of the deep neural network pre-trained in the weakly supervised learning module 120 with the derived combined data as inputs, and fine-tunes the pre-trained deep neural network by fine-tuning the weight of the pre-trained deep neural network based on the soft dice loss calculated from the difference between the estimated wrinkle data of the supervised learning module and the ground truth wrinkle data. Accordingly, referring to FIG. 4, the supervised learning device 200 may include a wrinkle region derivation module 210, a supervised learning module 220, and a supervised loss function computation module 230.

The wrinkle region derivation module 210 extracts the wrinkle RGB data by removing the false positives such as teeth and hair from the RGB data of the input images fewer than a predetermined number, and outputs the combined data by merging the texture maps derived by a Gaussian filter for the extracted wrinkle RGB data through a channel-wise concatenation operation, and the output combined data is provided to the supervised learning module 220.

Meanwhile, the wrinkle region derivation module 210 generates the consolidated ground truth wrinkle data by combining each binary wrinkle data extracted by a plurality of wrinkle masks predefined on the basis of the annotators A to C for the collected images fewer than a predetermined number through a majority voting algorithm.

That is, referring to FIG. 5, the wrinkle region derivation module 210 derives binary wrinkle data by each mask determined by each of the annotators A to C among the preprocessed facial RGB data, and combines the binary wrinkle data for each region to generate the consolidated ground truth wrinkle data.

The supervised learning module 220 estimates wrinkle data by fine-tuning a pre-trained deep neural network through the transfer learning of the pre-trained deep neural network in the weakly supervised learning muddle 120 by inputting the derived combined data. Here, the wrinkle data includes wrinkle presence and background features.

Although the process of performing the transfer learning of the pre-trained deep neural network on the basis of the weakly supervised learning module 120 is not specifically stated in this specification, this may be understood by those skilled in the art.

Subsequently, the supervised loss function computation module 230 fine-tunes the pre-trained deep learning neural network by fine-tuning the weight of the pre-trained deep neural network based on the soft dice loss calculated from the difference between the estimated wrinkle data of the supervised learning module and the ground truth wrinkle data of the wrinkle region derivation module 210. Here, the soft Dice loss may be expressed by Equation 3 below.

$$DL ( p , g ) = 1 - \frac{1}{C} {\sum }_{c = 1}^{C} \frac{2 {\sum }_{i = 1}^{N} {p}_{i , c} {g}_{i , c}}{{\sum }_{i = 1}^{N} {p}_{i , c} + {\sum }_{i = 1}^{N} {g}_{i , c}} \qquad [ Equation 3 ]$$

Here, C is the total number of classes to be classified, N is the total number of pixels, P_{i,c} represents the estimated probability for pixel i belonging to class c, and g_{i,c} represents the ground truth wrinkle label for pixel i belonging to class c, respectively.

Accordingly, referring to FIG. 6, by training a deep neural network for a predetermined number or more of facial RGB data ((a) denoted as face images), the texture maps ((b) denoted as masked texture maps) are estimated, and the deep neural network is trained by minimizing the MSE computed between the estimated texture map and the ground truth texture map, and wrinkle data ((c) denoted as manual wrinkle masks) including the presence of wrinkles and background features of fewer than a predetermined number of facial images is output by fine-tuning the pre-trained deep neural network, so that facial wrinkles with improved accuracy can be detected by using a lightweight device, thereby reducing time and cost required for the facial wrinkle detection.

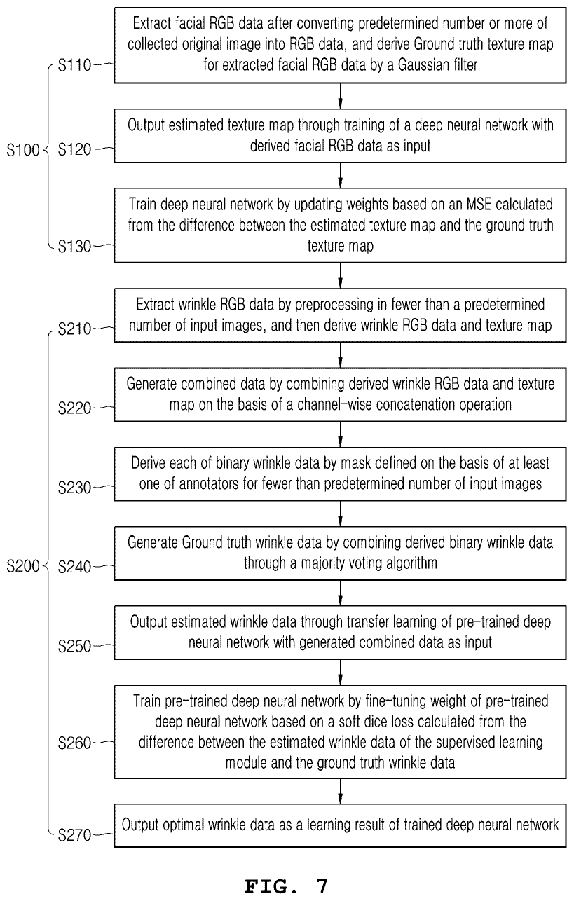

FIG. 7 is a flowchart showing the operation process of the facial wrinkle detection system of FIG. 1. Referring to FIG. 7, a facial wrinkle detection method according to another embodiment of the present disclosure will be described.

That is, the facial wrinkle detection system may further include a computer-readable recording medium having a program recorded for executing the facial wrinkle detection method on a computer, and may further include a computer program stored in the computer-readable recording medium for executing a remote control method on the computer by being coupled with the computer. Referring to FIG. 7, the facial wrinkle detection method of the computer program may include weakly supervised learning stage S100 and supervised learning stage S200.

In the weakly supervised learning stage S100, a predetermined number or more of collected original images are converted into RGB data, facial RGB data is extracted from the converted RGB data, and the ground truth texture map for the extracted facial RGB data is derived by a Gaussian filter in S110. The derived facial RGB data is input and learned by a deep neural network to estimate the texture map in S120. The deep neural network is trained by updating the weight of the deep neural network based on the MSE calculated from the difference between the estimated texture map and the ground truth texture map in S130.

In addition, in the supervised learning stage S200, fewer than a predetermined number of the input images are converted into RGB data, false positives such as teeth and hair are removed from the converted RGB data to extract wrinkle RGB data, and the texture map is derived by a Gaussian filter for the extracted wrinkle RGB data in S210, and the derived wrinkle RGB data and the texture map are merged on the basis of a channel-wise concatenation operation to output combined data in S220.

In addition, in the supervised learning stage S200, for fewer than a predetermined number of the collected images, binary wrinkle data is derived by using wrinkle masks predefined on the basis of at least one of the annotators A to C in S230, and the derived binary wrinkle data is combined through a majority voting algorithm to generate and output a consolidated ground truth wrinkle data in S240.

Next, in the supervised learning stage S200, the wrinkle data is estimated through the transfer learning of the pre-trained deep neural network in the weakly supervised learning stage S100 with the derived combined data as inputs in S250, and the pre-trained deep neural network is fine-tuned by updating the weight of the pre-trained deep neural network based on the soft dice loss calculated from the difference between the estimated wrinkle data and the ground truth wrinkle data in S260.

Accordingly, in the supervised learning stage S200, optimal wrinkle data is output on the basis of the trained deep neural network in S270, and a facial wrinkle model may be constructed with label information including the optimal wrinkle data and combined data.

For ease of understanding, one processor is sometimes described as being used, but those skilled in the art will recognize that a processor may include a plurality of processing elements and/or a plurality of types of processing elements. For example, a processor may include a plurality of processors or one processor and one controller. In addition, other processing configurations, such as a parallel processor, are also possible.

Here, a software may include a computer program, a code, an instruction or a combination of one or more thereof, and may configure a processor to perform a desired operation or may instruct a processor independently or collectively to perform a desired operation.

Software and/or information, signals and data may be permanently or temporarily embodied in any type of machine, a component, a physical device, virtual equipment, computer storage media or device, or transmitted signal waves, for interpretation by a control part or for providing instructions or data to a processor.

Software may be distributed across networked computer systems and stored or executed in the distributed manner. Software and data may be stored in one or more computer-readable recording media.

The method according to an embodiment may be implemented in the form of program instructions that can be executed through various computer means and recorded in a computer-readable medium. The computer-readable medium may include program instructions, data files, data structures, etc., alone or in combination. The program instructions recorded in the medium may be specially designed and configured for the embodiment or may be known and available to those skilled in the art of computer software.

Examples of computer-readable recording media include magnetic media such as hard disks, floppy disks, and magnetic tapes, optical media such as CD-ROMs and DVDs, magneto-optical media such as floptical disks, and hardware devices specifically configured to store and execute program instructions, such as ROM, RAM, and flash memory.

Examples of the program instructions include machine language codes, such as those produced by a compiler, and high-level language codes that can be executed by a computer by using an interpreter, etc.

The hardware devices described above may be configured to operate as one or more software modules to perform the operation of an embodiment, and vice versa.

Although the embodiments have been described above by way of limited embodiments and drawings, those skilled in the art will appreciate that various modifications and variations can be made from the above description. For example, suitable results may be achieved even if the described techniques are performed in a different order than described, and/or components of the described systems, structures, devices, circuits, etc. are coupled or combined in a different manner than described, or are replaced or substituted by other components or equivalents.

Therefore, the scope of the present disclosure should not be limited to the described embodiments, but should be defined not only by the claims set forth herein but also by equivalents thereof.

What is claimed is:

1. A facial wrinkle detection system comprising:
a weakly supervised learning device that converts each of a predetermined number or more of collected images into RGB data, extracts facial RGB data, and then estimates a texture map through training of a deep neural network by using the extracted facial RGB data as inputs; and
a supervised learning device that estimates wrinkle data through transfer learning of the deep neural network pre-trained on the basis of the weakly supervised learning device by using combined data of preprocessed wrinkle RGB data from fewer than a predetermined number of input images and the texture map as inputs.

2. The facial wrinkle detection system of claim 1, wherein the weakly supervised learning device comprises:
a preprocessing module that converts each of the predetermined number or more of the collected images to the RGB data, extracts RGB data of a facial region from the converted RGB data, and then derives a ground truth texture map for the facial RGB data through a Gaussian filter;
a weakly supervised learning module that trains the deep neural network with the facial RGB data and estimates a texture map; and
a weakly supervised loss function computation module that trains the deep neural network by updating weights based on an MSE calculated from the difference between the estimated texture map and the ground truth texture map.

3. The facial wrinkle detection system of claim 1, wherein the texture map comprises facial contours, curves, and skin texture features.

4. The facial wrinkle detection system of claim 2, wherein the supervised learning device comprises:
a wrinkle region derivation module that derives combined data by combining the preprocessed wrinkle RGB data from fewer than the predetermined number of the input images and a texture map derived from the wrinkle RGB data through the Gaussian filter, based on a channel-wise concatenation operation, derives each of binary wrinkle data with a mask determined by at least one annotator for fewer than the predetermined number of the input images, and outputs a consolidated ground truth wrinkle data by combining each of the binary wrinkle data through a majority voting algorithm;
a supervised learning module that estimates the wrinkle data through the transfer learning of the deep neural network pre-trained on the basis of the weakly supervised learning device with the combined data as the inputs; and
a supervised loss function computation module that fine-tunes a weight of the pre-trained deep neural network based on the soft dice loss calculated from the difference between the estimated wrinkle data and the ground truth wrinkle data,
wherein the supervised learning module is provided to output optimal wrinkle data as a result of the transfer learning of the fine-tuned deep neural network.

5. The facial wrinkle detection system of claim 1, wherein the wrinkle data comprises label information comprising wrinkle presence and background.

6. A facial wrinkle detection method performed on the basis of the facial wrinkle detection system of claim 1, wherein at least one processor comprised in the facial wrinkle detection system comprises:
a weakly supervised learning stage for converting each of the predetermined number or more of the collected images into the RGB data, extracting the facial RGB data, and then estimating the texture map through the training of the deep neural network by using the extracted facial RGB data as the inputs; and
a supervised learning stage for estimating the wrinkle data through the transfer learning of the deep neural network pre-trained on the basis of the weakly supervised learning device by using the combined data of the preprocessed wrinkle RGB data from fewer than the predetermined number of the input images and the texture map as the inputs.

7. The facial wrinkle detection method of claim 6, wherein the weakly supervised learning comprises:
converting each of the predetermined number or more of the collected images into the RGB data, extracting RGB data of a facial region from the converted RGB data, and then deriving a ground truth texture map for the facial RGB data through a Gaussian filter;
training the deep neural network with the facial RGB data and estimating a texture map; and
training the deep neural network by updating weights based on an MSE calculated from the difference between the estimated texture map and the ground truth texture map, and outputting an optimal texture map.

8. The facial wrinkle detection method of claim 6, wherein the supervised learning comprises:
deriving combined data by combining the preprocessed wrinkle RGB data from fewer than the predetermined number of the input images and a texture map derived from the wrinkle RGB data through the Gaussian filter, based on a channel-wise concatenation operation, deriving each of binary wrinkle data with a mask determined by at least one annotator for fewer than the predetermined number of the input images, and outputting a consolidated ground truth wrinkle data by combining each of the binary wrinkle data through a majority voting algorithm;
estimating the wrinkle data through the transfer learning of the deep neural network pre-trained on the basis of the weakly supervised learning device with the combined data as the inputs; and
fine-tuning a weight of the pre-trained deep neural network based on a soft dice loss calculated from the difference between the estimated wrinkle data of the supervised learning module and the ground truth wrinkle data,
wherein the supervised learning further comprises outputting optimal wrinkle data as a result of the transfer learning of the fine-tuned deep neural network.

9. A computer-readable recording medium having a program recorded for executing the facial wrinkle detection method of claim 6 on a computer.

10. A computer-readable recording medium having a program recorded for executing the facial wrinkle detection method of claim 7 on a computer.

11. A computer-readable recording medium having a program recorded for executing the facial wrinkle detection method of claim 8 on a computer.

12. An operating program of a facial wrinkle detection system, which is a computer program stored in a computer-readable recording medium for executing a facial wrinkle detection method on a computer by being coupled with the computer, wherein the facial wrinkle detection method comprises:
converting each of predetermined number or more of collected images into RGB data, extracting RGB data of a facial region from the converted RGB data, and then deriving a correct texture map for the facial RGB data through a Gaussian filter;
training a deep neural network with the facial RGB data and estimating a texture map; and
training the deep neural network by changing a weight of the deep learning neural network by updating weights based on an MSE calculated from the difference between the estimated texture map and the ground truth texture map,
wherein supervised learning stage comprises:
deriving combined data by combining preprocessed wrinkle RGB data from fewer than a predetermined number of input images and a texture map derived from the wrinkle RGB data through the Gaussian filter, based on a channel-wise concatenation operation, deriving each of binary wrinkle data with a mask determined by at least one annotator for fewer than the predetermined number of the input images, and outputting a consolidated ground truth wrinkle data by combining each of the binary wrinkle data through a majority voting algorithm;
estimating the wrinkle data through transfer learning of the deep neural network pre-trained on the basis of a weakly supervised learning device with the combined data as the inputs; and
fine-tuning a weight of the pre-trained deep neural network based on a soft dice loss calculated from the difference between the estimated wrinkle data of a supervised learning module and the ground truth wrinkle data,
wherein the supervised learning stage further comprises outputting optimal wrinkle data as a result of the transfer learning of the fine-tuned deep neural network.
